(19) United States
(12) Patent Application Publication
(10) Pub. No.: US 2026/0054331 A1
(43) Pub. Date: Feb. 26, 2026

(54) MAINTENANCE DEVICE FOR USE DURING MAINTENANCE AND/OR REPAIR OF A STORAGE AND RETRIEVAL UNIT IN A COLD STORE

(71) Applicant: Dematic GmbH, Heusenstamm (DE)

(72) Inventors: Jens Hußfeldt, Bad Homburg (DE); Michael Maurer, Hainburg (DE); Adi Ceric, Obertshausen (DE); Jan Paul Geiermann, Darmstadt (DE); Christoph Rath, Obernburg (DE); Marcel Schecker, Egelsbach (DE); Tobias Polanz, Görgeshausen (DE)

(21) Appl. No.: 19/103,948

(22) PCT Filed: Aug. 16, 2023
(86) PCT No.: PCT/EP2023/072570

§ 371 Date: Feb. 14, 2025

(30) Foreign Application Priority Data
Aug. 19, 2022 (DE) 102022120994.6

(51) Int. Cl. B23P 6/00

(52) U.S. Cl. CPC B23P 6/00

(57) ABSTRACT

The invention relates to a maintenance device for use during maintenance and/or repair of a storage and retrieval unit in a cold store. According to the invention, the maintenance device has a frame, which can be releasably fastened to a main switchgear cabinet of the storage and retrieval unit, and a tarpaulin, which can be releasably fastened to the frame, and the frame and the tarpaulin are formed and can be arranged with respect to one another in such a way that a maintenance space can be produced thereby on the main switchgear cabinet of the storage and retrieval unit. The invention is also directed to a multi-level storage and retrieval unit for use in a cold store and to an arrangement comprising a maintenance device according to the invention and a main switchgear cabinet of a storage and retrieval unit.

### CROSS REFERENCE TO RELATED APPLICATION

The present application is a national stage application of International Patent Application No. PCT/EP2023/072570 filed on Aug. 16, 2023, which claims the benefit of German Application No. 10 2022 120 994.6, filed on Aug. 19, 2022.

### TECHNICAL FIELD AND BACKGROUND

Maintenance device for use during maintenance and/or repair of a rack serving apparatus in a cold store

The disclosure relates to a maintenance device for use during maintenance and/or repair of a rack serving apparatus in a cold store, a multi-level rack serving apparatus for use in a cold store and an arrangement comprising a maintenance device and a main switching cabinet of a rack serving apparatus 8.

When using a rack serving apparatus in a cold store, it is difficult to carry out maintenance or repairs on the rack serving apparatus by reason of the adverse ambient conditions prevailing at this location, in particular by reason of the low temperatures. The adverse ambient conditions can be particularly obstructive during maintenance or repair of the components arranged in a main switching cabinet of the rack serving apparatus.

It is known from DE 10 2013 102 778 A1 to relocate a rack serving apparatus, which is used in a cold store, for maintenance or repair to a maintenance area which is sealed off from the cold store and is accessible only through an airlock. On the one hand, this has the disadvantage that the maintenance is very time-consuming because the rack serving apparatus has to be relocated to the maintenance area and accordingly has to be warmed up carefully in order to avoid damage thereto. Therefore, the rack serving apparatus is not used for its functional purpose for a correspondingly long period, thus reducing the throughput of the cold store. On the other hand, the provision of such a maintenance area is very costly and requires a corresponding amount of space in the storage facility which includes the cold store.

For the purpose of maintenance or repair within the cold store, it is also known to equip a multi-level rack serving apparatus, which is used therein, with a cabin which directly adjoins its main switching cabinet, forms a unit with its main switching cabinet, is heated and can be accessed by maintenance personnel. Such a unit consisting of a main switching cabinet and cabin can also be referred to as a walk-in main switching cabinet. However, the cabin or unit has the disadvantage that it is heavy and therefore the energy required to operate the multi-level rack serving apparatus is increased compared to a multi-level rack serving apparatus which does not have such a cabin or unit. In addition, it is necessary to provide such a cabin or unit on every multi-level rack serving apparatus used in the cold store, which results in high costs. A further disadvantage of the unit is that it takes up the entire width between two adjacent storage racks, i.e., the entire width of the rack aisle. In order to comply with the prescribed escape routes for personnel working in the cold store, the unit must be arranged at an appropriate height on the multi-level rack serving apparatus so that there is an adequate escape route through the rack aisle below it. However, if the unit is arranged in this manner, the maintenance personnel have to climb a ladder to reach the cabin, which puts their safety at risk, e.g., due to the risk of falling.

Maintenance or repair without a maintenance area or cabin also has, inter alia, the disadvantage that the personal protective equipment then required restricts the freedom of movement and, particularly due to the wearing of thick gloves, the haptics of the maintenance personnel and makes maintenance or repair more difficult.

### SUMMARY

Thereforef, the present disclosure provides a maintenance device, a multi-level rack serving apparatus and an arrangement comprising a maintenance device and a main switching cabinet of a rack serving apparatus, with which the time and costs for the maintenance and/or repair of a rack serving apparatus used in the cold store can be reduced and at the same time the conditions for the maintenance personnel can be improved.

In accordance with the disclosure, a maintenance device is provided for use during maintenance and/or repair of a rack serving apparatus in a cold store, wherein the maintenance device has a frame which can be releasably fastened to a main switching cabinet of the rack serving apparatus, and a tarpaulin which can be releasably fastened to the frame, and the frame and the tarpaulin are formed and can be arranged with respect to one another in such a way that a maintenance space can be provided thereby on the main switching cabinet of the rack serving apparatus.

In the assembled state, the maintenance device resembles a tent, which is why it can also be referred to as tent-like. The frame is a rigid structural element which, in the assembled state, supports the tarpaulin and with which substantially the outer shape of the maintenance space can be predetermined. Compared to the frame and a side wall used for a known cabin, the tarpaulin is a flexible and lightweight barrier element which can be used to produce a climatic barrier between the cold store and the maintenance space.

The tarpaulin is optionally formed in one piece, but a tarpaulin formed in multiple pieces can also be provided. The tarpaulin can be produced from a transparent or non-transparent material. The material of the tarpaulin is optionally a reinforced synthetic material which generally can also be used for a heavy goods vehicle tarpaulin. If the material of the tarpaulin is not transparent, a viewing window can be provided in the tarpaulin.

The maintenance space which can be provided by the maintenance device is to be understood as an enclosed space. However, the maintenance space can be accessed by maintenance personnel through an opening which can be closed e.g., by a zip fastener and/or hook-and-loop fastener and/or magnetic strip. The size of the maintenance space is optionally selected such that it can accommodate not only a person but also the tool required for the maintenance and/or repair.

In the maintenance space, a temperature can be generated which deviates from the temperature prevailing in the cold store. The cold store, which is also referred to as a refrigerated store or deep-freeze store or deep-freeze storage area, generally has prevailing temperatures between ca. −18 and −32 degrees Celsius. By contrast, in the maintenance space temperatures between −5 and +5 degrees Celsius are optionally achieved. For example, the air in the maintenance space can be heated using a fan heater. The maintenance space can be heated specifically only for the duration of maintenance and/or repair.

Therefore, with the maintenance device in accordance with the disclosure, maintenance personnel can be effectively protected from the ambient conditions prevailing in the cold store, in particular the low temperatures. This means that even more complex or longer maintenance work and repairs can be performed at the main switching cabinet whilst still complying with health and safety regulations.

When the maintenance device is in the assembled state, the tarpaulin hangs down from the frame or a component of the frame. At a lower end, the tarpaulin optionally terminates with a structure arranged under the maintenance device in such a way that heat convection between the cold store and the heated maintenance space and thus the energy requirement for heating the maintenance space are as low as possible.

The structure arranged under the maintenance device can be a support element, on which the main switching cabinet also stands. Such a support element is configured depending upon the design of the rack serving apparatus. The support element can be e.g., a support frame on a multi-level rack serving apparatus. However, if the rack serving apparatus is designed as a single-level rack serving apparatus and then-as described below-the main switching cabinet is arranged separately from the rack serving apparatus, the support element can be e.g., a storage floor of the cold store. The support element and/or the support frame are optionally designed in such a way that the heat convection between the cold store and the heated maintenance space is kept as low as possible.

The components housed in the main switching cabinet optionally include electronic components for a control device of the rack serving apparatus. In addition, further electronic components and/or electrical components and/or mechanical components and/or hydraulic components and/or pneumatic components can be stowed in the main switching cabinet.

The maintenance device in accordance with the disclosure can easily be built on the main switching cabinet and then also dismantled and removed from the main switching cabinet by reason of it being subdivided into a frame and tarpaulin. The time required for the maintenance can thus be reduced compared to the known solution with the maintenance area. Therefore, the productivity of the rack serving apparatus and also the throughput of the cold store can be increased. In addition, a separate maintenance area does not have to be provided in the storage facility, which potentially saves costs.

Moreover, the maintenance device can be set up specifically only for the duration of the maintenance and/or repair and can be stowed separately from the main switching cabinet or—in the case of a multi-level rack serving apparatus—can be stowed separately from the rack serving apparatus, e.g., outside the rack aisle, between maintenance and/or repair operations. Compared to the known solution with the cabin, the weight of a multi-level rack serving apparatus can be reduced, whereby the energy required for acceleration is reduced and the multi-level rack serving apparatus becomes more agile. Therefore, the productivity of the rack serving apparatus and also the throughput of the cold store can be increased. A single maintenance device can also be used for a plurality of main switching cabinets or multi-level rack serving apparatuses, as a result of which costs can be saved compared to the known solution with the cabin.

In an advantageous manner, provision is made that the frame and the tarpaulin are formed and can be arranged with respect to one another in such a way that they can be used to form three side walls and a roof in order to provide the maintenance space.

When the maintenance device is in the assembled state, a fourth side wall of the maintenance space can be formed by a suitable surface on the main switching cabinet. When the main switching cabinet is in a closed state, this is in particular one or more doors of the main switching cabinet. When the main switching cabinet is in an open state, this is in particular the rear wall thereof. In other words, the frame and the tarpaulin are then arranged on the main switching cabinet in such a way that the main switching cabinet closes the maintenance space on one side. A footprint of the maintenance space is then quadrangular and optionally rectangular.

The three side walls can be provided with magnetic strips e.g., on their edges, wherein the side walls can be releasably connected to one another or to the rack serving apparatus, in particular the main switching cabinet, by means of the magnetic strips. The connection can be released so that the maintenance space can be opened e.g., to allow maintenance personnel to enter.

When the tarpaulin is formed in one piece, it is optionally cut in such a way that the three side walls and the roof in the assembled state are formed substantially without any warping and without any unnecessary overlapping.

It is also feasible that the frame and the tarpaulin are formed and can be arranged with respect to one another in such a way that they can be used for forming two or four or more side walls in order to provide the maintenance space, and so the maintenance space then has a triangular or pentagonal or polygonal footprint.

In a particularly advantageous manner, provision is made that the frame comprises at least one pivoting element which is provided with a first pivoting means, in particular a groove, a long hole or a bolt, in order to produce a releasable pivoting connection to the main switching cabinet.

The pivoting element can be e.g., U-shaped, L-shaped, T-shaped or I-shaped. The frame can also comprise two or more pivoting elements which are the same or different.

The first pivoting means can be connected to a second pivoting means, which is arranged on the main switching cabinet and corresponds to the first pivoting means, in order to establish the releasable pivoting connection. The at least one pivoting element can thus be releasably fastened to the main switching cabinet. The first pivoting means, which is designed as a groove or long hole, can be hooked on a second pivoting means which is designed as a bolt. The reverse applies if the first pivoting means is a bolt.

The second pivoting means is not necessarily part of the maintenance device. This can also be part of the rack serving apparatus or the main switching cabinet and in particular cannot be provided exclusively for the maintenance device.

Provision is made that the at least one pivoting element, when attached to the main switching cabinet, is oriented initially in parallel with an upwardly directed extension direction of the main switching cabinet. The pivoting element is then located in a non-pivoted position. The pivoting element is then pivoted about an axis formed by the first and/or second pivoting means until the pivoting element is oriented substantially vertically to the upwardly directed extension direction of the main switching cabinet. The pivoting element is then located in a pivoted position. This simplifies the assembly of the frame.

As an alternative or in addition to the at least one pivoting element, the frame can also have a generally non-pivotable frame element, to which the tarpaulin can be fastened.

In a particularly advantageous manner, provision is also made that the frame comprises at least one supporting element, wherein the at least one pivoting element can optionally be supported in a pivoted position by means of the supporting element.

Alternatively, the supporting element can also be used to support the generally non-pivotable frame element, in particular in order to relieve the fastening points on the main switching cabinet.

The supporting element is arranged in particular at an end of the pivoting element or the generally non-pivotable frame element facing away from the main switching cabinet. The supporting element can be supported on the support element or support frame. When using the maintenance device on a main switching cabinet of a multi-level rack serving apparatus, the supporting element can also be supported on a railing of the multi-level rack serving apparatus.

The supporting element can also be used to move the pivoting element from the non-pivoted position to the pivoted position.

The frame can also comprise two or more supporting elements, wherein, when the maintenance device is in the assembled state, each supporting element supports in particular a pivoting element or a generally non-pivotable frame element. It is also feasible for a supporting element to support a plurality of pivoting elements or generally non-pivotable frame elements or for a pivoting element or a generally non-pivotable frame element to be supported by a plurality of supporting elements.

It is also feasible for the frame to be designed in one piece so that the supporting element forms a unit with the pivoting element or the generally non-pivotable frame element.

In an advantageous and structurally simple manner, the frame, optionally the pivoting element, is provided with at least one first fastener, in particular a pin or hook, and the tarpaulin is provided with at least one second fastener, in particular an eyelet, corresponding to the first fastener, wherein the tarpaulin can be releasably fastened to the frame by means of a connection of the first fastener to the second fastener.

Optionally, the frame has a plurality, in particular four, first fasteners and the tarpaulin has a plurality, in particular four, second fasteners corresponding thereto. The fasteners are optionally arranged in such a way that the tarpaulin can be fastened to the frame in an evenly distributed manner over the frame.

If the frame comprises a pivoting element, the tarpaulin is optionally fastened to the pivoting element when it is in the non-pivoted position. The connection between the first and second fastener prevents the tarpaulin from slipping down.

The disclosure is further directed to a multi-level rack serving apparatus for use in a cold store, wherein the multi-level rack serving apparatus comprises a lower running gear unit, at least one mast and a lifting carriage which can be moved on the mast and has a load-picker. In accordance with the disclosure, the multi-level rack serving apparatus has a main switching cabinet which is arranged directly above the lower running gear unit and is inaccessible.

Within the scope of the disclosure, the term directly is understood to mean that there is no escape route between the lower running gear unit and the main switching cabinet in the multi-level rack serving apparatus in accordance with the disclosure. In particular, no structure is arranged between the lower running gear unit and the main switching cabinet which makes it necessary to climb up to the main switching cabinet as in the case of the known solution with the cabin.

Nevertheless, the multi-level rack serving apparatus in accordance with the disclosure is not excluded from having a structural element, such as e.g., the support frame for the main switching cabinet, between the lower running gear unit and the main switching cabinet.

Within the scope of the disclosure, the term inaccessible means that the main switching cabinet is not large enough for a person to fit in next to the components accommodated therein, as is the case e.g., with the known solution with the unit consisting of the cabin and main switching cabinet. In other words, it is not possible to enter the main switching cabinet. Nevertheless, the main switching cabinet of the multi-level rack serving apparatus in accordance with the disclosure is accessible via a door and/or flap, so that the components accommodated therein can be worked on for maintenance and/or repair purposes.

The main switching cabinet of the multi-level rack serving apparatus accommodates in particular the control device-also referred to as the on-board control device-of the rack serving apparatus or the electronic components thereof. As described above, further components can be accommodated in the main switching cabinet. The maintenance device in accordance with the disclosure can be assembled on the main switching cabinet of the multi-level rack serving apparatus in accordance with the disclosure. It is possible that, in addition to the main switching cabinet, a further switching cabinet and/or switching box is provided on the multi-level rack serving apparatus in which further components are arranged. The multi-level rack serving apparatus in accordance with the disclosure can also be allocated a further main switching cabinet which is arranged separately from the multi-level rack serving apparatus in the cold store, in particular outside the rack aisle.

The multi-level rack serving apparatus is a single-track rail-guided vehicle for placing/removing stored goods into/out of storage in many, optionally four or more, or all storage rack levels of a storage rack. Stored goods can be e.g., pallets, containers, crates, boxes, bags and/or individual items. The multi-level rack serving apparatus can also serve a plurality of storage racks, e.g., adjacent storage racks in one rack aisle or storage racks arranged in a plurality of rack aisles.

The multi-level rack serving apparatus, also referred to as a stacker crane or storage and retrieval unit, has, in addition to the lower running gear unit, optionally an upper running gear unit which is disposed on an end of the mast remote from the lower running gear unit. The multi-level rack serving apparatus can be guided on a head cross beam via guide rollers provided on the upper running gear unit. The multi-level rack serving apparatus can include further components, such as e.g., a lifting mechanism having a cable or chain drive, ladders and power supplies.

The multi-level rack serving apparatus can be moved in three spatial directions or axes. The lower running gear unit, in particular with the running wheels provided thereon, is used to move the multi-level rack serving apparatus along a rail which is arranged in particular in a rack aisle. The mast disposed on the lower running gear unit and disposed substantially vertically to the rail is used to lift and lower the lifting carriage along the mast. The load picker of the lifting carriage can be moved substantially vertically to the rail and substantially vertically to the mast, i.e., transversely to a direction of travel of the multi-level rack serving apparatus and is used to pick up and deliver the stored goods.

The multi-level rack serving apparatus in accordance with the disclosure is designed especially for use in the cold store and has e.g., materials and lubricants suitable for this usage.

A horizontal main extension direction of the main switching cabinet runs in parallel with a direction of movement of the multi-level rack serving apparatus, i.e., in parallel with a main extension direction of the storage rack. A platform—also referred to as a podium-of the multi-level rack serving apparatus is optionally arranged in front of the main switching cabinet, i.e., next to the main switching cabinet when viewed in the main extension direction of the storage rack. In particular, the maintenance device is set up above this platform so that the maintenance personnel can “stand” on the platform and in the maintenance space provided by the maintenance device.

The multi-level rack serving apparatus in accordance with the disclosure has the advantage that the safety of maintenance personnel is improved by eliminating the need to climb ladders. In addition, the elimination of the cabin reduces the weight of the rack serving apparatus compared to the known solution.

In a particularly advantageous manner, provision is made that the interior of the main switching cabinet is not heated.

The electronic components accommodated in the main switching cabinet are designed to be cold-resistant for this purpose. In the present case, cold-resistant electronic components are electronic components which, in a switched-off state, can withstand the low temperatures prevailing in the cold store. Therefore, it is not necessary to heat the main switching cabinet in order to avoid damage to switched-off electronic components.

The disclosure is further directed to an arrangement comprising the maintenance device in accordance with the disclosure and a main switching cabinet of a rack serving apparatus in a cold store, wherein the maintenance device is assembled on the main switching cabinet.

In the case of the arrangement in accordance with the disclosure, the maintenance space is thus provided on the main switching cabinet. By reason of the simple assembly and disassembly of the maintenance device on/from the main switching cabinet, it is possible that the maintenance device in accordance with the disclosure is assembled on the main switching cabinet exclusively for the duration of the maintenance and/or repair and that the arrangement in accordance with the disclosure is also formed only for the duration of the maintenance and/or repair.

In a first particularly advantageous embodiment, provision is made that the rack serving apparatus is a multi-level rack serving apparatus in accordance with the disclosure and the maintenance device is assembled on the main switching cabinet which is arranged on the rack serving apparatus.

In other words, the maintenance device in the assembled state is then arranged on the multi-level rack serving apparatus in accordance with the disclosure. The maintenance space is thus formed on the multi-level rack serving apparatus, in particular above the platform.

In a further advantageous embodiment, provision is made that the rack serving apparatus is a multi-level rack serving apparatus and the main switching cabinet, on which the maintenance device is assembled, is arranged separately from the multi-level rack serving apparatus in the cold store.

In this case, the multi-level rack serving apparatus can be the multi-level rack serving apparatus in accordance with the disclosure or a multi-level rack serving apparatus which is known from the prior art.

In the case of this embodiment, the main switching cabinet is arranged in particular outside the rack aisle. The support element, on which the main switching cabinet stands, is formed in particular by the storage floor, on which the storage racks also stand.

The main switching cabinet is allocated to at least one multi-level rack serving apparatus, i.e., is connected thereto in terms of control and/or energy supply technology.

In a further advantageous embodiment, provision is made that the rack serving apparatus is a single-level rack serving apparatus and the main switching cabinet, on which the maintenance device is assembled, is arranged separately from the single-level rack serving apparatus in the cold store.

In contrast to the previously described embodiment of the rack serving apparatus, the single-level rack serving apparatus-also referred to as a shuttle-optionally serves only a single storage rack level of a storage rack. However, the single-level rack serving apparatus can also be designed in such a way that it can serve a small number of storage rack levels, in particular two or three.

The single-level rack serving apparatus can be moved along the racking aisle on two rails. The rails are provided in one of the storage rack levels allocated to the single-level rack serving apparatus. In each case, a rail is fastened to one of, or part of one of, the opposite storage racks separated by the rack aisle.

Stored goods can be loaded into, or unloaded from, the single-level rack serving apparatus on both sides of the rack aisle by means of a load-picker in order to place/remove the stored goods into/out of storage. The single-level rack serving apparatus can switch between storage rack levels via a lift optionally provided in the storage rack.

The single-level rack serving apparatus is designed specifically for use in the cold store and has e.g., materials and lubricants suitable for this usage.

The main switching cabinet associated with one or more single-level rack serving apparatuses is arranged separately from the single-level rack serving apparatus(es), in particular outside the rack aisle. The support element, on which the main switching cabinet stands, is formed in particular by the storage floor, on which the storage racks also stand.

The main switching cabinet optionally houses electronic components of a control device for the single-level rack serving apparatus(es). Each single-level rack serving apparatus is connected to the main switching cabinet for communication of control commands, which is effected in particular by means of contact lines. As described above, further components can be accommodated in the main switching cabinet. In particular, electrical components for supplying power to the at least one single-level rack serving apparatus are also stowed in the main switching cabinet, wherein each single-level rack serving apparatus is connected to the main switching cabinet, which is likewise effected in particular by means of contact lines.

The single-level rack serving apparatus can also have, in addition to the components arranged in the main switching cabinet, further components, such as an on-board control device. In particular, these are arranged in a switching box on the single-level rack serving apparatus.

The disclosure also relates to a cold store comprising an arrangement in accordance with the disclosure, at least one rack serving apparatus and at least one storage rack. Optionally, the cold store comprises a plurality of storage racks and rack serving apparatuses.

### DETAILED DESCRIPTION OF DRAWINGS

Further details of the disclosure will become clear from the following description of exemplified embodiments by reference to the drawing, in which

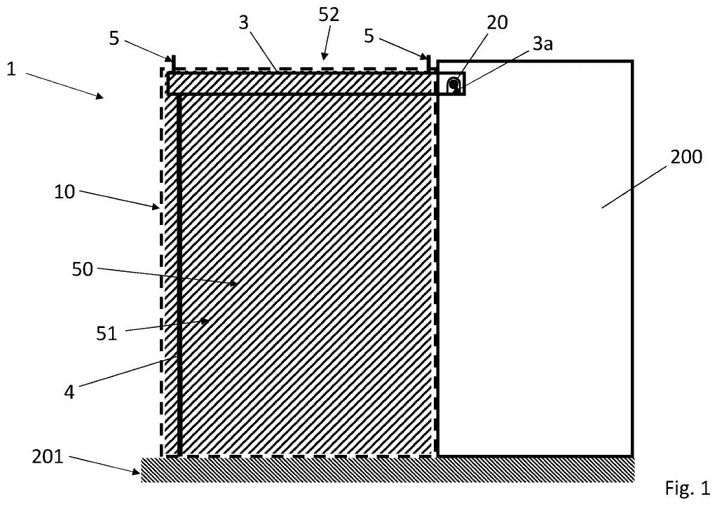

FIG. 1 shows a schematic side view of an embodiment of the arrangement in accordance with the disclosure including an embodiment of the maintenance device in accordance with the disclosure,

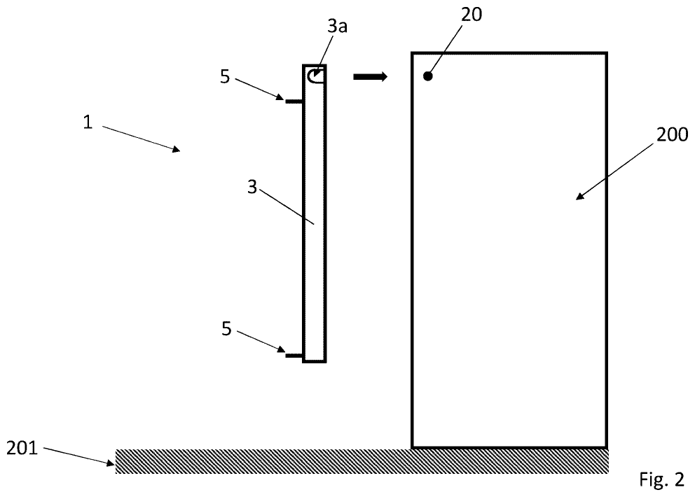

FIG. 2 shows a schematic side view of the arrangement of FIG. 1 in a first step of assembling the maintenance device on a main switching cabinet,

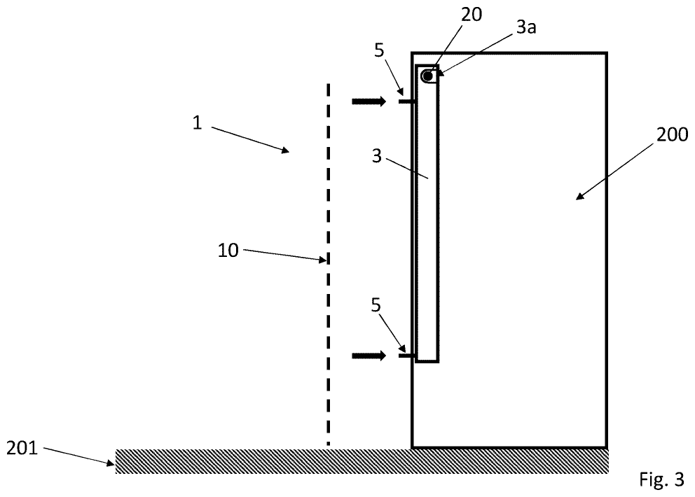

FIG. 3 shows a schematic side view of the arrangement of FIG. 1 in a second step of assembling the maintenance device on the main switching cabinet,

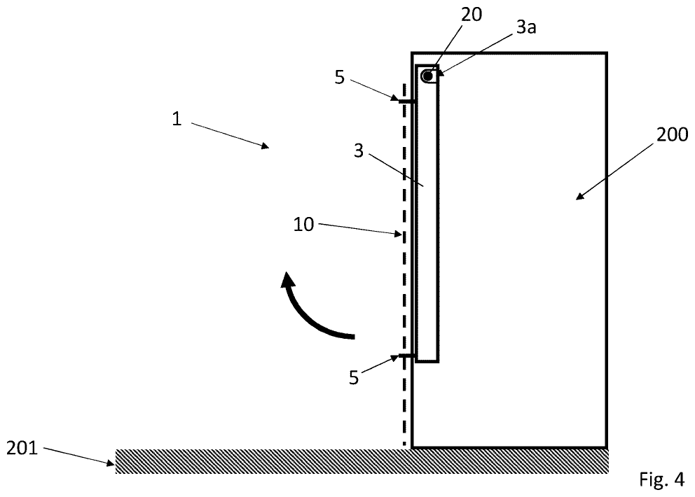

FIG. 4 shows a schematic side view of the arrangement of FIG. 1 in a third step of assembling the maintenance on the main switching cabinet,

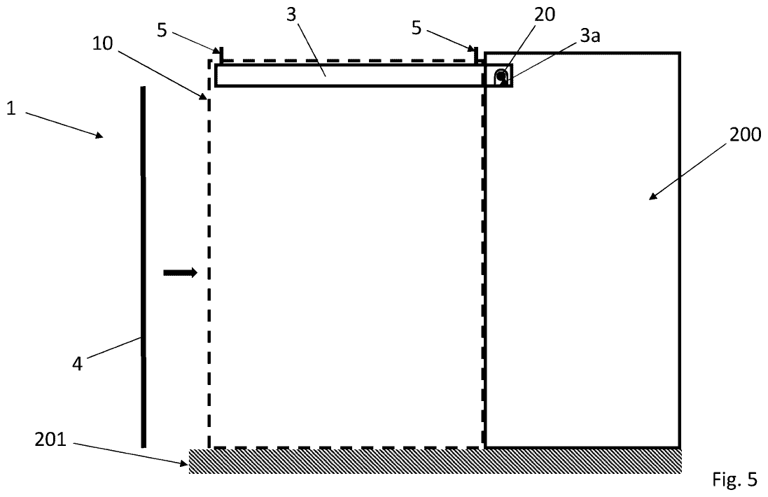

FIG. 5 shows a schematic side view of the arrangement of FIG. 1 in a fourth step of assembling the maintenance device on the main switching cabinet,

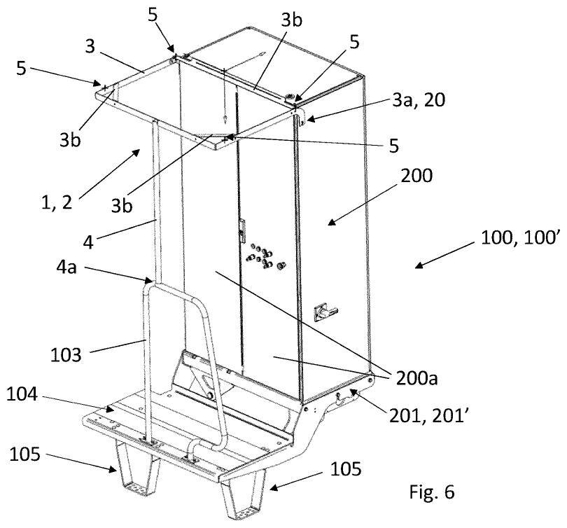

FIG. 6 shows a schematic perspective view of further embodiment of the arrangement in accordance with the disclosure,

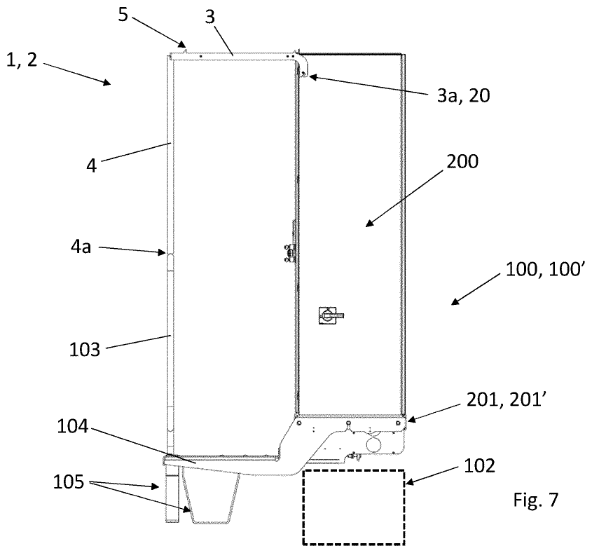

FIG. 7 shows a schematic side view of the arrangement of FIG. 6,

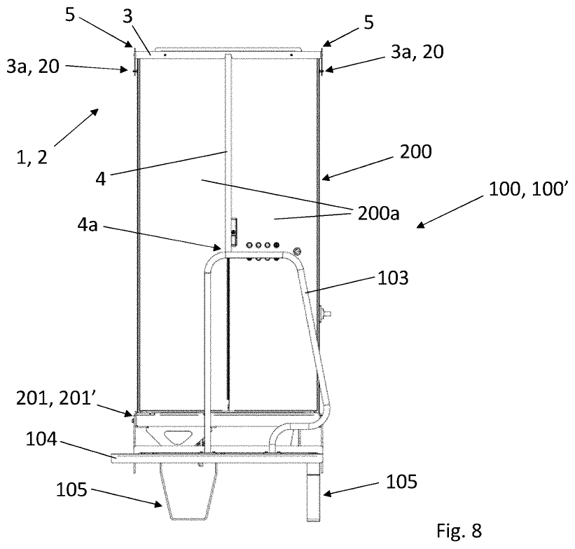

FIG. 8 shows a schematic front view of the arrangement of FIG. 6, and

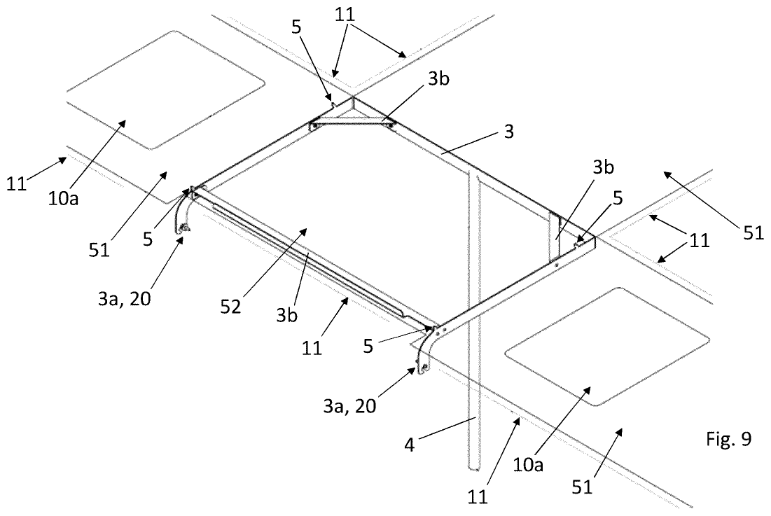

FIG. 9 shows a schematic folded-out view of an embodiment of the maintenance device in accordance with the disclosure.

### DETAILED DESCRIPTION

FIG. 1 is a schematic side view of an embodiment of the arrangement in accordance with the disclosure including an embodiment of the maintenance device 1 in accordance with the disclosure.

In addition to the maintenance device 1, the arrangement in accordance with the disclosure comprises a main switching cabinet 200, wherein the maintenance device 1 is assembled on the main switching cabinet 200. The main switching cabinet 200 is part of a rack serving apparatus 100 which is used in a cold store. The main switching cabinet 200 can be that of a multi-level rack serving apparatus 100′ (see also FIGS. 6 to 8) or that of a single-level rack serving apparatus or a plurality of single-level rack serving apparatuses.

If the main switching cabinet 200 is part of a multi-level rack serving apparatus 100′, the main switching cabinet 200 is arranged on the rack serving apparatus 100 itself. If the main switching cabinet 200 is part of one or more single-level rack serving apparatuses, the main switching cabinet 200 is arranged separately from the rack serving apparatus 100 in the cold store.

The main switching cabinet 200 stands on a support element 201. In the event that the main switching cabinet 200 is part of at least one single-level rack serving apparatus, the support element 201 is formed in particular by a storage floor of the cold store. In the event that the main switching cabinet 200 is part of a multi-level rack serving apparatus 100′, the support element 201 is in particular a support frame 201′ on the multi-level rack serving apparatus 100′ (see also FIGS. 6 to 8).

The maintenance device 1 comprises a frame 2 releasably fastened to the main switching cabinet 200, and a tarpaulin 10 releasably fastened to the frame 2. The frame 2 and the tarpaulin 10 are formed and arranged with respect to one another in such a way that a maintenance space 50 is provided on the main switching cabinet 200.

The frame 2 is a rigid structural element, with which the outer shape of the maintenance space 50 can be substantially predetermined. In contrast, the tarpaulin 10 is a flexible and lightweight barrier element which can be used to produce a climatic barrier between the cold store and the maintenance space 50. In the assembled state illustrated, the maintenance device 1 resembles a tent, which is why it can also be referred to as tent-like. Three side walls 51 and a roof 52 are formed with the maintenance device 1 in order to provide the maintenance space 50. Of the side walls 51, only one side wall 51 is illustrated in this view. A fourth side wall 51 of the maintenance space 50 is formed by f a suitable surface on the main switching cabinet 200. When the main switching cabinet 200 is in a closed state, this is a door of the main switching cabinet 200. When the main switching cabinet 200 is in an open state, this is the rear wall thereof. In the present case, the maintenance space 50 has a quadrangular footprint.

The maintenance space 50 is a closed space which, however, is accessible to maintenance personnel through an opening, not illustrated, which can be closed e.g., by a zip fastener and/or hook-and-loop fastener and/or magnetic strip. The size of the maintenance space 50 is selected such that it can accommodate the tool required for the maintenance and/or repair in addition to a person. The maintenance space 50 can be heated to simplify maintenance and/or repair of the components arranged in the main switching cabinet 200.

In the embodiment shown, the frame 2 is formed by a pivoting element 3 and a supporting element 4. Alternatively, a plurality of supporting elements 4 can also be provided. The pivoting element 3 is supported against the support element 201 by the supporting element 4.

In the present case, the pivoting element 3 is U-shaped and has, at two limb ends, a first pivot 3a which is designed as a groove. The first pivot 3a is connected to second pivot 20 which are fastened to both sides of the main switching cabinet 200 and are designed as bolts.

In addition, the pivoting element 3 has four first fastener 5 which are designed as pins and of which only two are illustrated. Instead of the pin, a hook can also be provided as the first fastener 5. The two first fastener 5 illustrated are arranged spaced apart from one another on the pivoting element 3, as are the two first fastener 5 which are arranged therebehind in this view. A plan view thus shows a rectangular pattern. The first fastener 5 are thus optionally arranged in such a way that the tarpaulin 10 can be fastened to the frame 2 in an evenly distributed manner over the frame 2.

The tarpaulin 10 is releasably fastened to the pivoting element 3 with the aid of the first fastener 5 and the second fastener, not illustrated, which correspond to the first fastener.

As an alternative to the one-piece design of the pivoting element 3, the frame 2 can also have two pivoting elements 3, each of which is then pivotably connected to one side of the main switching cabinet 200. Each of the pivoting elements 3 can then be supported by means of a supporting element 4 or both pivoting elements 3 together can be supported by means of a single supporting element 4. It is possible that in the case of two pivoting elements, the first pivoting means 3a is designed as a long hole.

As an alternative or in addition to the at least one pivoting element 3, the frame 2 can also have a generally non-pivotable frame element, to which the tarpaulin 10 can be fastened.

The tarpaulin 10 hangs down from the pivoting element 3 and terminates with the support element 201 at a lower end. As a result, the maintenance space 50 is closed in this area and heat convection between the cold store and the heated maintenance space 50 is minimised.

FIG. 2 shows a schematic side view of the arrangement of FIG. 1 in a first step of assembling the maintenance device 1 on the main switching cabinet 200,

In the first assembly step, the pivoting element 3 is guided in a non-pivoted position towards the main switching cabinet 200 and is releasably fastened thereto. For this purpose, the pivoting element 3, in the area of the first pivoting means 3a designed as a groove, is slid onto the second pivoting means 20 designed as a bolt, whereby a pivoting connection is established. In the non-pivoted position, the pivoting element 3 is oriented in parallel with an upwardly directed extension direction of the main switching cabinet 200.

FIG. 3 shows a schematic side view of the arrangement of FIG. 1 in a second step of assembling the maintenance device 1 on the main switching cabinet 200.

In the second assembly step, the tarpaulin 10 is releasably fastened to the pivoting element 3, or to the first fastener 5 provided thereon, by means of the second fastener provided thereon but not shown. To this end, the second fastener which, in the present case, are designed as eyelets are slid onto the first fastener 5 which are designed as pins.

FIG. 4 shows a schematic side view of the arrangement of FIG. 1 in a third step of assembling the maintenance device 1 on the main switching cabinet 200.

In the third assembly step, the pivoting element 3 with the tarpaulin 10 releasably fastened thereto is pivoted about a pivot axis, which is formed by the second pivoting means 20 designed as a bolt, from the non-pivoted position to a pivoted position (see FIG. 5). The supporting element 4 can also be used for pivoting purposes.

FIG. 5 shows a schematic side view of the arrangement of FIG. 1 in a fourth step of assembling the maintenance device 1 on the main switching cabinet 200.

In this case, the pivoting element 3 is shown in the pivoted position, wherein the pivoting element 3 is oriented substantially perpendicularly to an upwardly directed extension direction of the main switching cabinet 200. The tarpaulin 10 releasably fastened thereto hangs down from the pivoting element 3.

In the fourth and final assembly step, the supporting element 4 is positioned under the pivoting element 3 in order to support the pivoting element 3 in the pivoted position on the support element 201. The supporting element 4 is arranged at an end of the pivoting element 3 facing away from the main switching cabinet 200, so that the maintenance space 50 is as easily accessible as possible. In addition, if the main switching cabinet 200 is part of a multi-level rack serving apparatus 100′ and therefore is arranged on the multi-level rack serving apparatus 100′, there is an adequate escape route through the maintenance device 1 (see FIGS. 6 to 8).

FIG. 6 shows a schematic perspective view of a further embodiment of the arrangement in accordance with the disclosure.

In the embodiment of the arrangement shown in this case, the main switching cabinet 200 is part of a rack serving apparatus 100 designed as a multi-level rack serving apparatus 100′. The main switching cabinet 200 is thus arranged on the rack serving apparatus 100 itself and is arranged directly above a lower running gear unit 102 (see FIG. 7) of the multi-level rack serving apparatus 100′. In addition, it is not possible to enter the main switching cabinet 200. The main switching cabinet 200 has two doors 200a, through which maintenance personnel can gain access. Optionally, the interior of the main switching cabinet 200 is not heated.

In the present case, the support element 201, on which the main switching cabinet 200 stands, is designed as a support frame 201′. In the present case, the multi-level rack serving apparatus 100′ has a platform 104 which, together with the support frame 201′, forms a cohesive assembly. A railing 103 is arranged at the end of the platform 104 facing away from the main switching cabinet 200.

In the present case, the maintenance device 1 is illustrated without a tarpaulin 10 so that the frame 2 and the fastening of the maintenance device 1 to the main switching cabinet 200 can be seen. However, the dimensions of a maintenance space 50 which can be provided can be surmised from the arrangement and shape of the frame.

The frame 2 comprises a pivoting element 3 and a supporting element 4. The supporting element 4 supports the pivoting element 3 against the railing 103 of the multi-level rack serving apparatus 100′. This produces a supporting point 4a. However, such a supporting point 4a can also be arranged at a different location on the multi-level rack serving apparatus 100′, so that the pivoting element 3 is supported by the supporting element 4 e.g., against the platform 104 arranged in front of the main switching cabinet 200.

Maintenance personnel can stand on the platform 104 in order to perform maintenance and/or repairs to the main switching cabinet 200 or the components accommodated therein. Two step treads 105 are provided on the platform 104 and make it easier for maintenance personnel to get to the platform 104 which is arranged at a low height above a storage floor of the cold store. In contrast to the known design of the multi-level rack serving apparatus 100′ with a cabin located high up, the maintenance personnel do not have to climb up a ladder to the main switching cabinet 200. This prevents falls which would put the safety of maintenance personnel at risk.

The pivoting element 3 located in the pivoted position is U-shaped and has stiffening struts 3b at its two corners and in the area of the fastening points. However, within the scope of the disclosure the stiffening struts 3b are merely optional. In addition, the pivoting element 3 has a total of four first fastener 5.

FIG. 7 shows a schematic side view of the arrangement of FIG. 6.

This view clearly shows that there is an adequate escape route for personnel working in the cold store between the main switching cabinet 200 and the railing 103 as well as between the main switching cabinet 200 and the supporting element 4. The tarpaulin 10, not illustrated, has closable openings on both sides, so that the escape route is not restricted or is restricted to a tolerable extent by the tarpaulin 10. Alternatively, the tarpaulin 10 can be quickly removed from the frame 2 or the pivoting element 3 in order to make an escape.

The lower running gear unit 102 of the multi-level rack serving apparatus 100′, above which the main switching cabinet 200 is arranged directly, is illustrated schematically by the dashed box.

FIG. 8 shows a schematic front view of the arrangement of FIG. 6.

This view shows how the pivoting connection formed from the first pivoting means 3a and the second pivoting means 20 is formed between the pivoting element 3 and the main switching cabinet 200.

FIG. 9 shows a schematic perspective folded-out view of an embodiment of the maintenance device 1 in accordance with the disclosure.

The tarpaulin 10 is shown folded out in this view, although, when the maintenance device 1 is in the assembled state, said tarpaulin hangs down from the pivoting element 3 to form a climatic barrier between the maintenance space 50 and the cold store. The folded-out view clearly shows the outline of the tarpaulin 10, i.e., how the tarpaulin 10 is cut to form the side walls 51 and the roof 52.

In this embodiment, the tarpaulin 10 is formed in one piece. However, it is possible for the tarpaulin 10 to be formed in multiple pieces. Magnetic strips 11 are attached to the edges of the side walls 51 and serve to releasably connect the side walls 51 to one another or a side wall 51 to the main switching cabinet 200. The magnetic strips 11 render it possible for the maintenance space 50 to be closed and thus to be able to be heated efficiently, but to be able to be opened temporarily for access by maintenance personnel. As an alternative to the magnetic strips 11, it is also feasible to have a zip fastener or hook-and-loop fastener.

Since, in the present case, the tarpaulin 10 is not transparent, viewing windows 10a are provided therein. Within the scope of the disclosure, these are merely optional and can also be omitted accordingly.

This view clearly also shows the total of four first fastener 5 and the arrangement thereof on the pivoting element 3.

### LIST OF REFERENCE SIGNS

1 maintenance device
2 frame
3 pivoting element
3a first pivot
3b stiffening strut
4 supporting element
4a supporting point
5 first fastener
10 tarpaulin
10a viewing window
11 magnetic strip
12 second fastener
20 second pivot
50 maintenance space
51 side wall
52 roof
100 rack serving apparatus
100′ multi-level rack serving apparatus
102 lower running gear unit
103 railing
104 platform
105 step tread
200 main switching cabinet
200a door
201 support element
201′ support frame

1. A maintenance device for use during maintenance and/or repair of a rack serving apparatus in a cold store, said maintenance device comprising: a frame which can be releasably fastened to a main switching cabinet of the rack serving apparatus, and a tarpaulin which can be releasably fastened to the frame, and wherein the frame and the tarpaulin are formed and can be arranged with respect to one another in such a way that a maintenance space can be provided thereby on the main switching cabinet of the rack serving apparatus.

2. The maintenance device as claimed in claim 1, wherein the frame and the tarpaulin are formed and can be arranged with respect to one another in such a way that they can be used to form three side walls and a roof in order to provide the maintenance space.

3. The maintenance device as claimed in claim 1, wherein the frame comprises at least one pivoting element which is provided with a first pivot, in particular a groove, a long hole or a bolt, in order to produce a releasable pivoting connection to the main switching cabinet.

4. The maintenance device as claimed claim 1, wherein the frame comprises at least one supporting element, wherein the at least one pivoting element can optionally be supported in a pivoted position by the supporting element.

5. The maintenance device as claimed claim 1, wherein the frame, optionally the pivoting element, is provided with at least one first fastener, in particular a pin or hook, and the tarpaulin is provided with at least one second fastener, in particular an eyelet, corresponding to the first fastener, wherein the tarpaulin can be releasably fastened to the frame by a connection of the first fastener to the second fastener.

6. A multi-level rack serving apparatus for use in a cold store, the multi-level rack serving apparatus comprising: a lower running gear unit, at least one mast and a lifting carriage which can be moved on the mast and has a load-picker, characterised in that the rack serving apparatus has a main switching cabinet which is arranged directly above the lower running gear unit and cannot be entered.

7. The multi-level rack serving apparatus as claimed in claim 6, wherein the interior of the main switching cabinet is not heated.

8. An arrangement comprising a maintenance device as claimed in claim 1 and a main switching cabinet of a rack serving apparatus in a cold store, wherein the maintenance device is assembled on the main switching cabinet.

9. The arrangement as claimed in claim 8, wherein the rack serving apparatus is a multi-level rack serving apparatus as claimed in claim 6 and the maintenance device is assembled on the main switching cabinet which is arranged on the rack serving apparatus.

10. The arrangement as claimed in claim 8, wherein the rack serving apparatus is a multi-level rack serving apparatus or a single-level rack serving apparatus and the main switching cabinet, on which the maintenance device is assembled, is arranged separately from the rack serving apparatus in the cold store.
